(19) United States
(12) Patent Application Publication
(10) Pub. No.: US 2011/0015856 A1
(43) Pub. Date: Jan. 20, 2011

(54) FUEL EQUIVALENCY FOR DATA SERVICES

(75) Inventor: John C. Arnold, Canton, MI (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignees: XM Satellite Radio, Inc., Washington, DC (US); Sirius XM Radio, Inc., New York, NY (US)

(21) Appl. No.: 12/839,360

(22) Filed: Jul. 19, 2010

Related U.S. Application Data
(60) Provisional application No. 61/226,471, filed on Jul. 17, 2009.

(51) Int. Cl. G01C 21/36; G06F 3/048; G08G 1/123; G10L 13/08

(52) U.S. Cl. 701/201; 715/771; 340/995.27; 704/260; 704/E13.011

(57) ABSTRACT

A fuel information data service system is presented. In exemplary embodiments of the present invention a fuel information data service can include a controller operable to receive information regarding costs of various types of fuel, and to correlate such costs of fuel information to actual operating costs for a given vehicle, based on a known consumption efficiency for a plurality of types of fuel for that vehicle, to calculate a FuelEQ or fuel equivalency for each fuel offering. In exemplary embodiments of the present invention an exemplary system can further include a presentation device coupled to the controller where the controller is further operable to present such FuelEQ information expressed as a cost per distance traveled. In exemplary embodiments of the present invention a location finding module can be provided, and in addition to displaying various fuel costs and corresponding FuelEQ values, a fuel data system can also display distance and direction data for each available fueling station to a user. In exemplary embodiments of the present invention such a location finding system can send navigational directions to a selected fuel station based on a user selection. In exemplary embodiments of the present invention an exemplary system can alert a user when the vehicle is low on gas and has passed within a predetermined distance to a refueling station with a price lower than a threshold Fuel EQ value (value of cost per distance for fuel) set by the user. In exemplary embodiments of the present invention a navigation system can be used as a location finding module, to both determine distances and direction to a variety of local fueling or energy stations, as well as to calculate and display navigational directions to a selected fuel station in response to a user selection.

### CROSS-REFERENCE TO RELATED APPLICATIONS

This application claims priority to U.S. Provisional Patent Application No. 61/226,471, filed on Jul. 17, 2009, which is hereby incorporated herein by reference.

### TECHNICAL FIELD

The present invention relates generally to systems and methods of providing data services in a mobile environment, and more particularly to providing fueling data services including fuel equivalency data.

### BACKGROUND OF THE INVENTION

Satellite radio currently offers well over a hundred channels of content over a large geographic footprint. A portion of the content can include data services that can work well with current navigation services. A large portion of the existing market and future lower tier the market will not have access to navigation systems or services. Current navigation services store databases of maps and data and rely on complicated navigational systems. Furthermore, with the advent of vehicles capable of using various different types of fuel sources or various grades of fuels, and those vehicles operating more efficiently or less efficiently as a function of which grade of fuel, type of fuel, or fuel/energy source is being used, the ability to determine the true cost to operate a vehicle can be deceiving or at least difficult to determine. In general, such true cost of operation is not simply the cost per gallon of a particular fuel.

### SUMMARY OF THE INVENTION

In exemplary embodiments of the present invention, a method of presenting fuel data can include retrieving costs of fuel/energy source data, correlating such costs of fuel/energy source data with fuel/energy source efficiency data for a given vehicle to generate fuel equivalency data as operating cost per unit distance, and presenting the fuel/energy source equivalency data to a user.

In exemplary embodiments of the present invention, a fuel equivalency information service system can include a server that gathers fuel information, a satellite transmission or other wireless transmission system that broadcasts fuel data information in a digital stream to a plurality of subscriber units or to at least one receiver, a user interface that enables a user to selectively enter preferences and choose fueling station locations based on cost per distance for a given fuel type and on further criteria selected from current location, track, fuel type, and preferred brand.

In exemplary embodiments of the present invention, a fuel equivalency information service system can include a controller operable to receive costs of fuel/energy source information, and correlate the cost of fuel/energy source information for a given vehicle having a known consumption efficiency for a plurality of types of fuel/energy sources used by the given vehicle. The system can further include a presentation device coupled to the controller where the controller is further operable to present the cost of fuel information on the basis of a cost per distance.

### BRIEF DESCRIPTION OF THE DRAWINGS

FIG. 1 is a screen shot of an exemplary fuel equivalency presentation for regular, medium and premium fuel grades of gasoline in accordance with an exemplary embodiment of the present invention;

FIG. 2A is screen shot of an exemplary fuel equivalency presentation for regular gasoline versus E85 gasoline/ethanol fuel in accordance with an exemplary embodiment of the present invention; and

FIG. 2B is screen shot of a second exemplary fuel equivalency presentation for regular gasoline versus E85 gasoline/ethanol fuel in accordance with an exemplary embodiment of the present invention.

### DETAILED DESCRIPTION OF THE DRAWINGS

Satellite radio operators are providing digital radio broadcast services covering the entire continental United States with the hope of further covering other areas of the Americas. These services offer approximately 100 channels or more, of which nearly 50 channels in a typical configuration provides music with the remaining stations offering news, sports, talk and data channels. Briefly, the service provided by Sirius XM Radio, for example, includes a satellite X-band uplink to two satellites which provide frequency translation to the S-band for re-transmission to radio receivers on earth within a coverage area. Radio frequency carriers from one of the satellites can, for example, also be received by terrestrial repeaters. The content received at the repeaters can then be retransmitted at a different S-band carrier to the same radios that are within their respective coverage areas. These terrestrial repeaters facilitate reliable reception in geographic areas where Geosynchronous Satellite reception is obscured by tall buildings, hills or other natural obstructions, tunnels, or other obstructions. The signals transmitted by the satellites and the repeaters are received by satellite digital audio radio system (SDARS) receivers which can be located in automobiles, for example, or, for example, in handheld or in stationary units for home or office use. Such SDARS receivers can, for example, be designed to receive one or both of the satellite signals as well as the signals from the terrestrial repeaters, and then, for example, combine or select one of the signals as the receiver output.

Each SDARS receiver contains a unique Hardware Identification number (HWID), which is assigned during the manufacturing process and is used by SDARS Service Providers to enable or disable the radio to receive subscribed services, such as music and talk programming. In addition, these subscribed services could include data services, such as weather and traffic data feeds or other custom data feeds. The custom data feeds are typically uniquely enabled by the SDARS Service Provider for select subscriber groups.

Although existing telematics systems using cellular and Global Positioning System (GPS) technology, such as, for example, the General Motors On-Star™ system, currently track vehicles and provide services such as dispatching emergency road side assistance upon the detection of certain events at the vehicle, no existing system graphically provides enhanced data services without providing or interoperating with a navigation system. Such a navigation system typically requires additional memory and resources to operate. Additionally, no existing system provides fuel equivalency information for the growing number of vehicles that are adapted to use various types and/or grades of fuels, or even different energy sources, such as, for example, gasoline/electric hybrid vehicles.

In exemplary embodiments of the present invention fuel data, and FuelEQ data, described below, can be provided, for example, as a custom data feed in a satellite radio. In similar fashion as for traffic data, an exemplary satellite radio can access a service channel, or a dedicated broadcast channel in which fuel data for a given locale can be received.

In exemplary embodiments of the present invention, exemplary fuel data service systems can include GPS position information, or alternatively, cellular location finding techniques can be used to determine the user's current position. For example, such location finding technology can use, for example, time of arrival, time-distance of arrival and triangulation. Or, alternatively, a user can enter his or her then current locale, and the fuel data for that locale can be accessed by the receiver, and all other locales filtered out.

In exemplary embodiments of the present invention, the notion of Fuel Equivalency or “FuelEQ” can be defined and utilized. Fuel Equivalency is a cost per unit distance that takes into account both (i) the cost of each available fuel or other energy source, as well as (ii) the operating efficiency using each such fuel or energy source. Thus, it is a much more accurate assessment of operating cost than mere “miles per gallon.” It is noted that although the examples provided herein generally deal with gasoline at various octane grades and/or in different mixtures (E85), exemplary embodiments of the present invention are not limited thereto. “Fuel” or “Energy Source” as used and contemplated herein is not limited to various grades of gasoline or gasoline mixtures, but can include other fuels or energy sources such as, for example, ethanol, electricity, natural gas, hydrogen (e.g., liquid or gaseous), and other sources of propulsion as are, or as may be, used in a vehicle.

In exemplary embodiments of the present invention, an exemplary system can enhance basic customer displays which provide average miles per gallon without regard to fuel types used or their effect on actual miles per gallon. Variables such as octane efficiency, fuel type (e.g., E85, Alternative, etc.), and engine design technology can affect the miles per gallon (mpg) that is displayed and experienced by a given driver in a given context. In exemplary embodiments of the present invention, for vehicles that are able to accept multiple fuel types, multiple grades of octane, multiple energy sources (e.g., a gasoline/electric hybrid), etc., FuelEQ can, for example, provide the actual cost of driving per mile (or any cost per unit distance) while compensating for all major variables to engine performance. In exemplary embodiments of the present invention a FuelEQ value can be displayed, for example, for each fuel type, octane option, and energy source. In exemplary embodiments of the present invention the correlation of FuelEQ to relevant fuel/energy price data can, for example, be available for consumer display or, for example, a text to speech module can enable an audible “read-out” of such information. In exemplary embodiments of the present invention, when using SIRIUS XM fuel price data, the cheapest nearby fuel/energy prices can be researched, and this data can be correlated with FuelEQ to provide the best financial option for the user or driver.

Next described are various exemplary use cases of exemplary embodiments of the present invention. In a first example, an analysis is done between regular gasoline and various premium grades of gasoline. Often times premium vehicles require premium gasoline for optimum efficiency. When gas prices rise, however, drivers tend to purchase lower grades of fuel hoping to save a few dollars. However, consumers may not know that the advertised fuel economy for the vehicle is based on premium gasoline, if in fact the engine was designed for premium fuel. As a result, fuel efficiency is generally decreased when using lower octane fuels. This effect is normal and by design, and is due to sensors that are designed to detect engine detonation which often occurs when using low grade fuel; these sensors will counteract detonation by minimizing the uncontrolled combustion that low grade fuel can generate inside a high power engine. The net result of lower than specified octane levels in fuel thus yields noticeably less engine power and fuel efficiency for the automobile. It is known, for example, that in such instances the mpg can be reduced by as much as 3-5 miles per gallon when using regular octane versus premium in a vehicle whose engine was designed for premium gasoline. Thus. when calculating the actual cost of driving the vehicle using a lower octane fuel, it is observed that the Fuel Equivalency—i.e., the consumer cost per mile for the specific vehicle in question, is more advantageous for premium fuel versus regular fuel, for example. Table 1 below shows that although premium gasoline may cost more per gallon, it actually constitutes a more cost effective fuel source taking into consideration the rated fuel efficiency for the vehicle for the respective types of fuels. In general this will depend upon the relative costs of premium and regular (or other lower octane fuels), as well as the fuel efficiency at each octane level.

TABLE 1
FuelEQ of Regular vs. Premium Fuel

| | Price | Fuel type | FuelEQ |
|---|---|---|---|
| Octane | (Price/gal) | (mpg) | (Price/mile) |
| Regular | $ 2.75 | 22 | $ 0.13 |
| Premium | $ 2.89 | 25 | $ 0.12 |

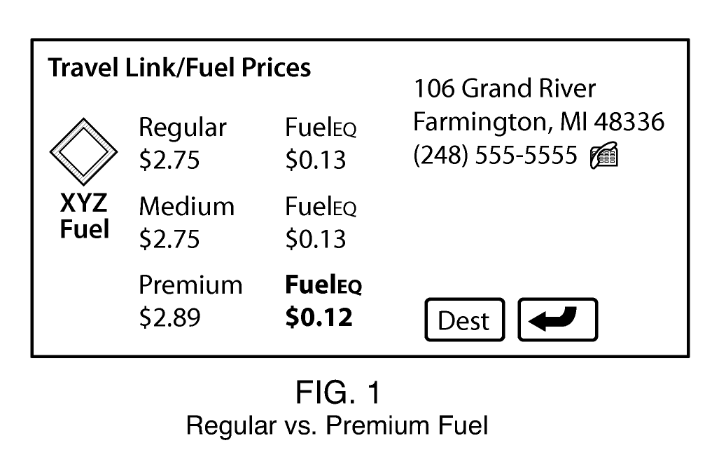

Thus, in the example of Table 1, it is easily seen that the best option for this premium designed vehicle is to use premium gasoline despite the lower price (here 14 cents lower per gallon) for regular fuel. When the FuelEQ is displayed next to the price per gallon indicator listed for a given fuel station, a driver can be fully informed, and can thus decide accordingly. A graphical representation of such an exemplary display is provided in FIG. 1.

Thus, with reference thereto, FIG. 1 shows an exemplary display of fuel types and process in a left-hand column, and the FuelEQ for each fuel type in a right-hand column. The fuel prices and FuelEQ are for an exemplary “XYZ Fuel” gas station in Farmington, Mich. The exemplary display can be provided on the display of a satellite radio receiver, such as, for example, those arranged to receive SiriusXM broadcasts.

In exemplary embodiments of the present invention, in addition to comparisons between fuel grades and their corresponding FuelEQ, regular fuel can be compared with alternative fuels such as, for example, mixtures of gasoline and ethanol. One common example of such mixtures is E85 fuel. E85 is an alcohol fuel mixture that typically contains a mixture of up to 85% denatured fuel ethanol and gasoline or other hydrocarbon by volume. On an undenatured basis, the ethanol component ranges from 70% to 83%. E85 as a fuel is widely used in Sweden and is becoming increasingly common in the United States, mainly in the Midwest where corn is a major crop and is the primary source material for ethanol fuel production. It is also available across most of the Maxol chain in Ireland. In Finland E85 is available from various St1 chain locations in Helsinki.

One complication associated with the general use of E85 as an automotive fuel is that the use of gasoline in an engine with a high enough compression ratio to use E85 efficiently would likely result in catastrophic failure due to engine detonation, as the octane rating of gasoline is not high enough to withstand the greater compression ratios in use in an engine specifically designed to run on E85. Use of E85 in an engine designed specifically for gasoline would result in a loss of the potential efficiency that it is possible to gain with this fuel. Using E85 in a gasoline engine has the drawback of achieving lower fuel economy as more fuel is needed per unit air (stoichiometric fuel ratio) to run the engine in comparison with gasoline. This corresponds to a lower heating value (units of energy per unit mass) for E85 than gasoline. Some vehicles can actually be converted to use E85 despite not being specifically built for it. Because of the lower heating value E85 has a cooler intake charge, which coupled with its high stability level from its high octane rating, has also been used as a “power adder” in turbocharged performance vehicles.

Thus, E85 consumes more fuel in flex fuel type vehicles when the vehicle uses the same compression for both E85 and gasoline because of its lower stoichiometric fuel ratio and lower heating value. The European car maker Saab currently produces a flex fuel version of their 9-5 sedan which consumes the same amount of fuel whether running E85 or gasoline, for example (although that model is not available in the United States). So in order to save money at the pump with E85 with current flex fuel vehicles available, for example, in the United States, the price of E85 must be much lower than gasoline. E85 has generally been about 15% less expensive in most areas of the Midwestern United States, although some stations tend to sell the fuels at comparable prices.

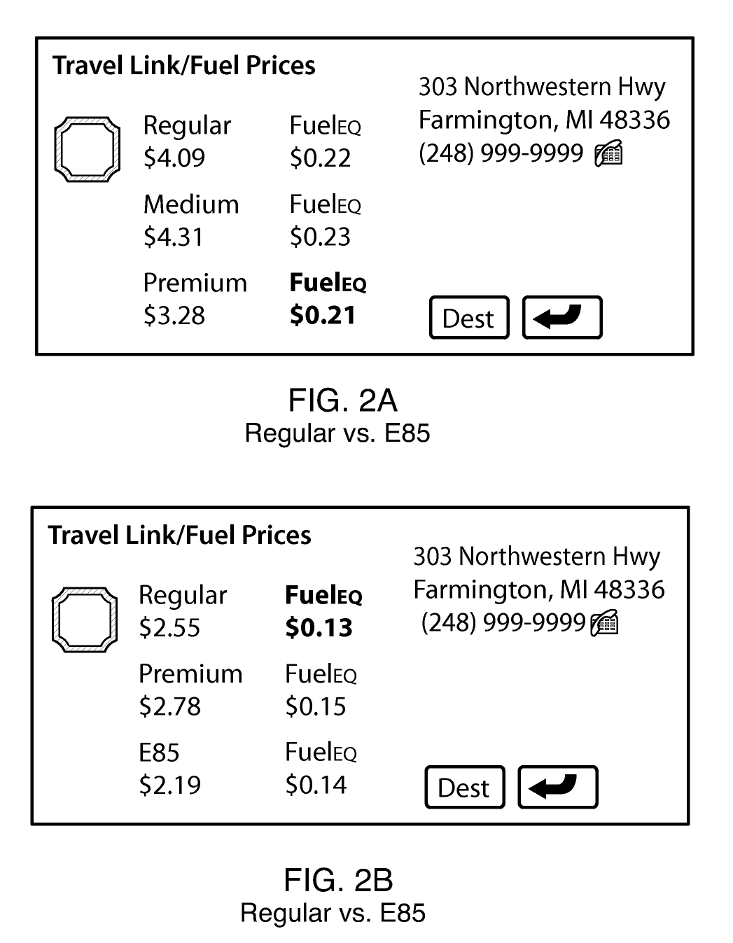

Thus, as in the comparison of regular vs. premium gasoline as described above, a similar condition manifests with E85. For the reasons described above, it is known that ethanol can be up to 30% less efficient when compared to regular fuel for engines that are designed to accept both regular gasoline and ethanol, such as are found in “flex-fuel vehicles” or “FFV”s. Therefore it may be advantageous to purchase regular gasoline over E85, depending on the price of both fuels at the time, the relative efficiencies of these fuel options, and the design of a given user's engine. This is where the FuelEQ calculations according to the present invention can be most useful to a user, who may have neither the inclination nor the resources to perform complex calculations every time he or she needs to purchase automotive fuel. Table 2 provided below, and the exemplary screenshots provided in FIGS. 2A and 2B illustrate various exemplary possible scenarios where the prices of regular gasoline and E85 are at various price-points, and the decision to purchase one or another based on FuelEQ can vary based on a number of factors.

TABLE 2A
Regular vs. E85 I

| | | Fuel | FuelEQ |
|---|---|---|---|
| | Price | Efficiency | Value |
| Octane | December 2008 | (mpg) | (Price/mile) |
| Regular | $4.09 | 19 | $ 0.22 |
| E85 | $3.28 | 16 | $ 0.21 |

TABLE 2B
Regular vs. E85 II

| | | Fuel | |
|---|---|---|---|
| | Price | Efficiency | FuelEQ |
| Octane | June 2009 | (mpg) | (Price/mile) |
| Regular | $2.55 | 19 | $ 0.13 |
| E85 | $2.19 | 16 | $ 0.14 |

From Table 2 it can readily be observed that the best solution is dependent on the prices for both regular gasoline and E85 prevalent at the time. Utilizing the FuelEQ information in combination with SIRIUS XM Fuel Price data, for example, a driver can be informed of the best options for that snapshot in time.

Similarly, FIGS. 2A and 2B depict exemplary screen shots or display views of the information provided in Table 2A and Table 2B, respectively. FIG. 2A presents an exemplary display shot of the December 2008 prices then prevalent at an exemplary gasoline station. Then, regular gasoline was $4.09 per gallon, and E85 was $3.28 per gallon. With a price disparity of $0.81, even given the higher efficiency of regular gasoline, the FuelEQ for E85 was nonetheless one cent per mile lower, and thus E85 was the then best choice. However, some seven months later, in June 2009, when regular gasoline was selling for $2.55 at the same gasoline station, and E85 was selling there for $2.19, the price disparity of only $0.36, given the relative inefficiency of E85, made the FuelEQ of E85 one cent per mile higher, and thus made regular gasoline the better choice. It is noted that the exemplary screen shots of FIG. 2 also provide a cost per gallon and a corresponding FuelEQ value for “Premium” grade gasoline. However, in December 2008 its FuelEQ was the highest of the three options, at $0.23, and in June 2009 its FuelEQ was also the highest of the three options, at $0.15. Thus, premium grade gasoline was never in the running in this example, the only viable choices being either regular gasoline or E85, depending on the situation.

Similar analyses can be performed for gasoline vs. electric models, and other forms of fuel/energy, such as, for example, hydrogen, or bio-diesel. It is noted in this connection that vehicles having both electricity and gasoline options will be available in the near future. An owner of such a vehicle can make decisions on the FuelEQ of each available fueling option knowing the cost of obtaining electricity which can vary based on the utility company providing such fuel or even on the time of day the vehicle is being charged. This fuel source can be compared with gasoline or other fuel sources as the case may be.

For example, a 2007 study by the non-profit Electric Power Research Institute (EPRI) calculated that powering a plug-in hybrid electric vehicle (PHEV) would cost the equivalent of roughly 75 cents per gallon of gasoline—a price not seen at the pump for 30 years. The calculation was made using an average cost of electricity of 8.5 cents per kilowatt hour and the estimated distance the car would travel on one charge, versus a car that gets 25 miles per gallon and is powered by $3 per gallon gasoline. Of course, changing any of those variables will change these relative costs. For example, substituting a car that gets 50 miles per gallon doubles the comparative electrical cost (though in this example, it still works out much cheaper to use electric than gasoline). On the other hand, in some areas where wind or hydropower is wasted at night—just when the PHEV might be charging—the utility might drop the kilowatt hour cost to two to three cents, making the charge much less costly.

Thus, once hybrid gasoline-electric vehicles become common, it will be very useful to have not only a display of local electric “energy stations,” but the FuelEQ of their offerings as well as the FuelEQ of local gasoline stations—or even E85 stations (if the hybrid's gasoline engine can also run E85, for example).

In exemplary embodiments of the present invention where a location finding module is used, in addition to displaying various fuel costs and corresponding FuelEQ values, a fuel data system can also display distances and direction data for each available fueling station displayed to a user. In exemplary embodiments of the present invention such a location finding system can send navigational directions to a selected fuel station based on a user selection.

In exemplary embodiments of the present invention where a location finding module is used, an exemplary system can alert a user when the vehicle is low on gas and has passed within a predetermined distance to a refueling station with a price lower than a threshold value for cost per distance for fuel set by the user. Thus, for example, in the example of Table 2 and FIG. 2, a user could set a maximum FuelEQ value of $0.13, in which case regular gasoline would be chosen automatically in June 2009 (FIG. 2B).

In exemplary embodiments of the present invention a navigation system can be used as a location finding module, to both determine distances and direction to a variety of local fueling or energy stations, as well as to calculate and display navigational directions to a selected fuel station in response to a user selection.

The description above is intended by way of example only and is not intended to limit the present invention in any way except as set forth in the following claims. For example, although embodiments are described with respect to a satellite digital audio radio, the embodiments and contemplated claim scope are equally applicable to other satellite and land based digital audio systems and broadcast methods, such as, for example, HD Radio, DAB, ATSC Mobile, MediaFlo, as well as two way systems such ICO satellite/terrestrial as well as 4G LTE or WiMAX. Furthermore, the exemplary embodiments described herein can also be applicable to broadcast as well as two way communication systems such as cellular.

In other aspects, the embodiments are not limited to obtaining fuel data completely from a wireless source. In exemplary embodiments of the present invention, a user can, for example, manually input fuel data information into an exemplary FuelEQ system. In yet another embodiment, for example, a visual recognition system can determine fuel information using a camera and input the fuel data into an exemplary FuelEQ system.

Further, in exemplary embodiments of the present invention, an external device such as an MP3 player or an iPOD can download information (where the external device can be connected via a hardwired connection or a wireless connection such as Bluetooth or WiFi or cellular) from the Internet or an Intranet source and the external device can then provide the latest fuel information to an exemplary FuelEQ system within a vehicle where the algorithm will enable the user to decide to purchase fuel in a most cost effective manner. It is noted that the external device can also provide the fuel data to the FuelEQ system in a vehicle via a hardwired connection or a wireless connection such as Bluetooth.

Of course, other user considerations can alter a fuel or energy purchasing decision and thus additional information such as, for example, fueling station location options from a current location, a track, a fuel type, and a preferred brand may also be considered, for example, among other considerations. It is also noted that an exemplary FuelEQ system can also be embedded as part of software code running on the external device. Thus, for example, an iPOD, a smartphone, iPhone, portable GPS can further include software for executing a FuelEQ algorithm that can then enable the external device itself or a system within the vehicle to present FuelEQ information to enable a user to make an informed fueling/energy obtaining decision.

What is claimed:

1. A method of presenting fuel data, comprising:
retrieving fuel cost information for at least two fuel options;
using the fuel cost information and a known consumption efficiency for a plurality of types of fuel for a given vehicle to calculate a fuel equivalence value for each fuel option; and
presenting the fuel equivalence value as a cost per distance traveled.

2. The method of claim 1, wherein the fuel cost information comprises octane levels.

3. The method of claim 1, wherein the cost per distance traveled is expressed as at least one of a cost per mile, a cost per kilometer and a cost per unit distance.

4. The method of claim 1, wherein retrieving the fuel cost information is done automatically by visual recognition of fuel pricing at a fueling station.

5. The method of claim 1, wherein retrieving the fuel cost information is done by manually inputting fuel cost information.

6. The method of claim 1, wherein retrieving the fuel cost information is done by receiving a broadcast of fuel data information in a digital stream.

7. The method of claim 6, wherein the fuel data information is filtered by location using location finding technology selected among GPS, time of arrival, time-distance of arrival and triangulation.

8. The method of claim 1, wherein retrieving the fuel cost information is done by receiving a broadcast of fuel data information from a satellite digital audio radio system (SDARS) transmission.

9. The method of claim 1, wherein retrieving the fuel cost information is done by receiving a broadcast of fuel data information from a terrestrial digital FM transmission.

10. The method of claim 1, wherein retrieving the fuel cost information is done by receiving a broadcast of fuel data information from at least of a cellular transmission source, a WiFI transmission source, and a WiMax transmission source.

11. The method of claim 1, wherein the method sends navigational directions to a selected fuel station based on a user selection.

12. The method of claim 1, wherein the method alerts a user in a vehicle when the vehicle is low on gas and passed within a predetermined distance to a refueling station with a price lower than a threshold value for cost per distance for fuel set by the user.

13. A fuel information service system, comprising:
a server arranged to gather fuel information;
a satellite transmission system arranged to broadcast fuel data information in a digital stream to a plurality of subscriber units; and
a user interface in which a user can selectively enter preferences and choose fueling station locations based on cost per distance for a given fuel type and on further criteria selected from current location, track, fuel type, and preferred brand.

14. The fuel information service system of claim 13, wherein the satellite transmission system broadcasts baseline information and updates.

15. The fuel information service system of claim 13, wherein the system further includes a voice control system and a text to speech response system.

16. The fuel information service system of claim 13, wherein the plurality of subscriber units are satellite digital audio radio system receivers capable of receiving both audio and data.

17. A fuel information service system, comprising:
a controller operable to:
receive fuel cost information;
use the fuel cost information and a known consumption efficiency for a plurality of types of fuel for a given vehicle to calculate a fuel equivalence value for each fuel option; and
a presentation device coupled to the controller,
wherein the controller is further operable to present the fuel equivalence information as a cost per distance traveled.

18. The fuel information service system of claim 17, wherein the system comprises a satellite digital audio radio system radio combined with a navigation system used to provide directions to a selected fuel station.

19. The fuel information service system of claim 17, wherein the system comprises a satellite digital audio radio system radio.

20. The fuel information service system of claim 17, wherein the system comprises at least one among a satellite digital audio radio system radio, a cellular receiver, a WiFI receiver, and a WiMax receiver.

21. The fuel information service system of claim 17, wherein the system is part of a portable cellular phone, a smartphone, an MP3 device, or a podcast device.
